(19) United States
(12) Patent Application Publication
(10) Pub. No.: US 2018/0223493 A1
(43) Pub. Date: Aug. 9, 2018

(54) CRANE BARGE CONVERSION TO A JACK-UP UNIT

(71) Applicant: ZENTECH, INC., Houston, TX (US)

(72) Inventor: Ramesh MAINI, Houston, TX (US)

(21) Appl. No.: 15/892,954

(22) Filed: Feb. 9, 2018

Related U.S. Application Data
(60) Provisional application No. 62/456,823, filed on Feb. 9, 2017.

(51) Int. Cl. E02B 17/08; B66C 23/18; E02B 17/00

(52) U.S. Cl. CPC E02B 17/08; E02B 17/0034; B66C 23/18

(57) ABSTRACT

The present disclosure generally relates to offshore vessels, such as crane barges, retrofitted with jack-up legs, and methods of forming the same. The offshore vessels may be American-made or be otherwise Jones Act compliant.

### CROSS-REFERENCE TO RELATED APPLICATIONS

This application claims benefit of U.S. provisional patent application Ser. No. 62/456,823 filed Feb. 9, 2017, which is herein incorporated by reference.

### BACKGROUND

### Field

Embodiments of the present disclosure generally relate to offshore crane barges.

### Description of the Related Art

Decommissioned offshore vessels are often forgotten and allowed to go into a state of disrepair, or may be sunk to form artificial reefs. Occasionally, the decommissioned offshore vessels may be stripped for scrap. However, none of these outcomes utilize a decommissioned offshore vessel to full potential, especially considering the labor and engineering man-hours put into the erection of the vessels. Similar issues exist with underutilized vessels, even prior to decommissioning.

Therefore, there is a need for a new use of decommissioned or underutilized offshore vessels.

### SUMMARY

The present disclosure generally relates to offshore vessels, such as crane barges, retrofitted with jack-up legs, and methods of forming the same. The offshore vessels may be American-made or be otherwise Jones Act compliant.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 is a view of a prior art crane barge.

FIG. 2 is a schematic side view of a crane barge, according to one aspect of the disclosure.

FIGS. 3A and 3B are plan views of a crane barge, according to aspects of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to offshore vessels, such as crane barges, retrofitted with jack-up legs, and methods of forming the same. The offshore vessels may be American-made or be otherwise Jones Act compliant.

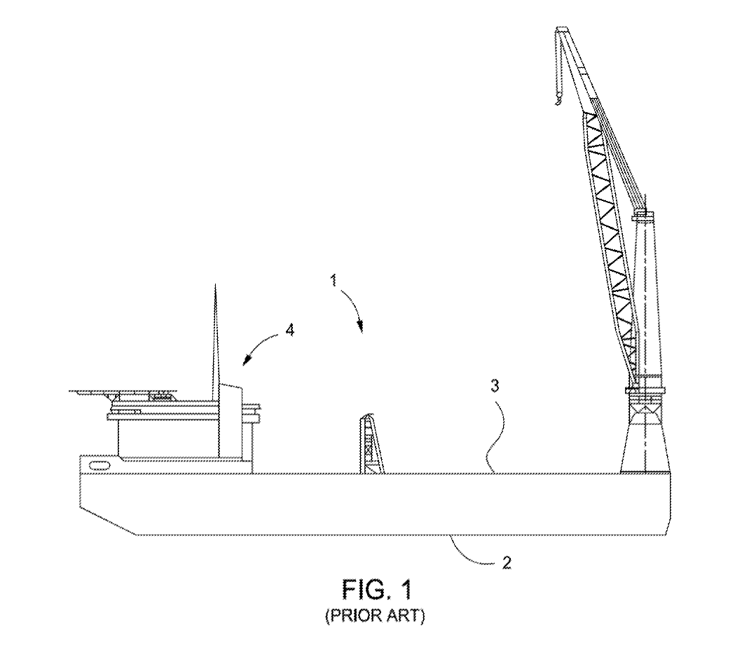

FIG. 1 is a view of a prior art crane barge 1. The crane barge 1 includes a hull 2 with a working deck 3 and, at the front of the hull 2, a superstructure 4 for crew accommodation. The crane barge 1 may be used to carry loads to an offshore site, and to lift a load from the working deck 3 of the crane barge 1 to a desired position, such as on an offshore platform, or lift the load from a starting position to the working deck 3 of the hull 2.

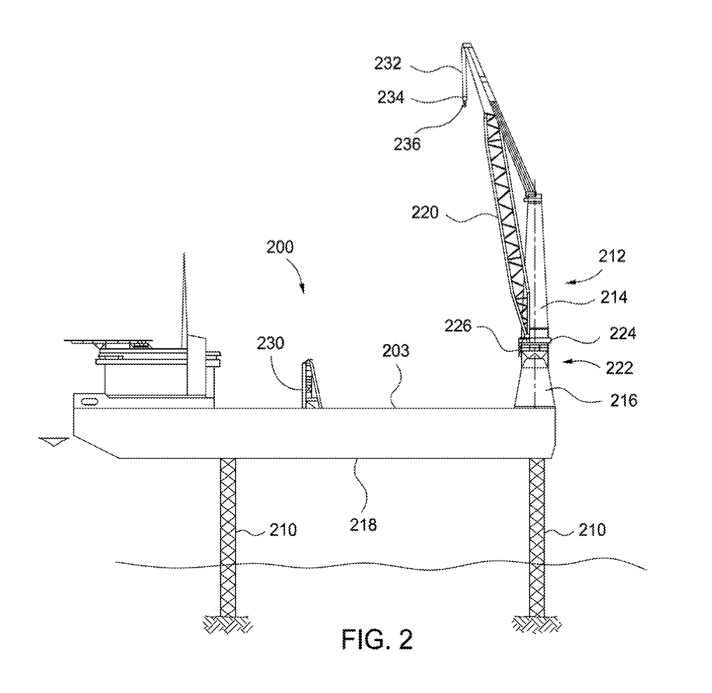

FIG. 2 is a schematic elevation of a crane barge 200, according to one aspect of the disclosure. The crane barge 200 is similar to the crane barge 1, however, the crane barge 200 has been converted to include a plurality of jack-up legs 210. Stated otherwise, the crane barge 200 was initially designed and used as a crane barge—without jack-up legs 210—for a period of time, prior to being retrofitted to include the jack-up legs 210. Suitable jack-up legs 210 are described in U.S. Pat. No. 6,076,996. However, other jack-up leg configurations are contemplated.

The crane barge 200 may be retrofitted to include a desired number of jack-up legs 210 with footings, such as three, four, six, or eight jack-up legs 210. It is to be appreciated that the size and number of jack-up legs 210 may be selected to bear desired structural loads. Although the jack-up legs 210 are shown in an operating position wherein the crane barge is raised above the surface of the water, it is to be understood the jack-up legs 210 are vertically actuatable, and may be raised and lowered to position the crane barge for operation thereof or to facilitate transport.

The crane barge 200 includes a revolving hoist crane 212 disposed at the rear end of the hull on a deck 203. The hoist crane 212 includes a substantially hollow vertical pedestal 214 positioned on a base 216, which is fixed to a hull 218 of the crane barge 200. The hoist crane 212 includes a boom 220. An annular bearing structure 222 extends around the vertical pedestal 214 and guides and carries a boom connection member 224 so that the boom connection member 224, and therefore the boom 220, can rotate about the pedestal 214. In such an example, the boom connection member 224 forms a substantially horizontal pivot axis so that the boom 220 can also be pivoted up and down. At least one drive motor 226 is positioned to displace the boom connection member 224 along the annular bearing structure 222. The drive motor 226 may, for example, drive a pinion which engages with a toothed rack or another drive mechanism around the pedestal 214. A boom rest 230 is mounted to a topside of the hull 218 for supporting the boom 220 when the hoist crane 212 is not in operation.

The hoist crane 212 includes a hoisting cable 232 from which a block 234 and a hook 236 are suspended to facilitate hoisting of loads with the hoist crane 212. One or more winches (not shown) may be coupled to the cable 232. The cable 232 may extend through or over the hollow vertical pedestal 214, over a cable guide, and couple to the block 234 and hook 236 to allow actuation of the hook 236. It is contemplated that the winch may be disposed interior of, or exterior to the column 214. In one example, the winch may be disposed above the column 232 and behind the boom 220, level with an operator's cabin.

While FIG. 2 illustrates one example of a crane barge 200, it is to be understood that other crane barges, having similar or different configurations, may advantageously be utilized according to aspects of the disclosure. In such examples, the crane barges may similarly be retrofitted with jack-up legs 210.

Retrofitting of crane barges, such as crane barge 200, with jack-up legs 210 allows the crane barges to be used for installation of equipment, such as wind turbines, or for offshore platform decommissioning, or for offshore platform support, among other operations and functions. In contrast, the crane barge 1 (shown in FIG. 1), may be unsuitable for wind turbine installation due to limitations of the crane barge 1. Thus, retrofitting a crane barge with jack-up legs 210 greatly increases the usability of the crane barge 200, at a significant cost savings compared to construction of a new jack-up crane barge.

In one example, the crane barge 200 may be an American-made vessel and otherwise complies with The Marine Merchant Act of 1920 (The Jones Act). Compliance with the Jones Act facilitates ease of maintenance by providing American-crewed vessels access to the crane barge 200 for retrofitting and maintenance. Additionally, the crane barge 200 may enter a United States port for maintenance, docking, storage, and the like.

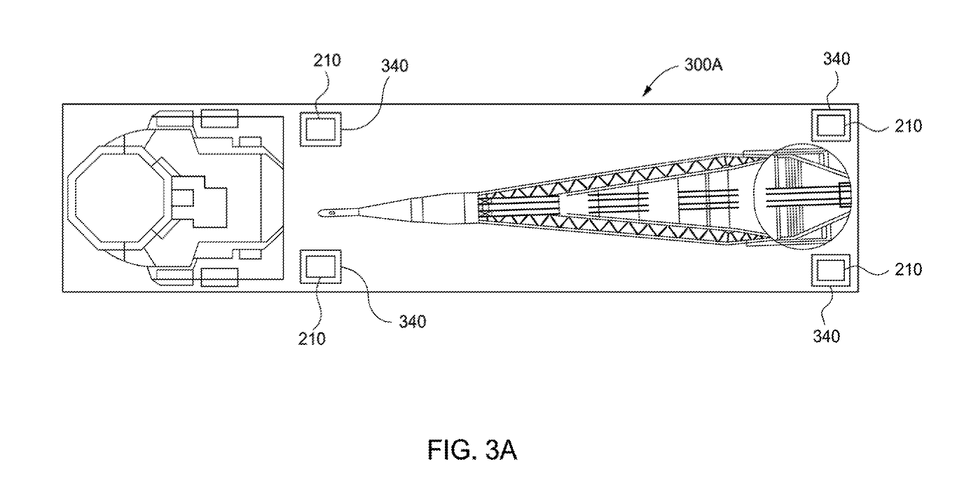

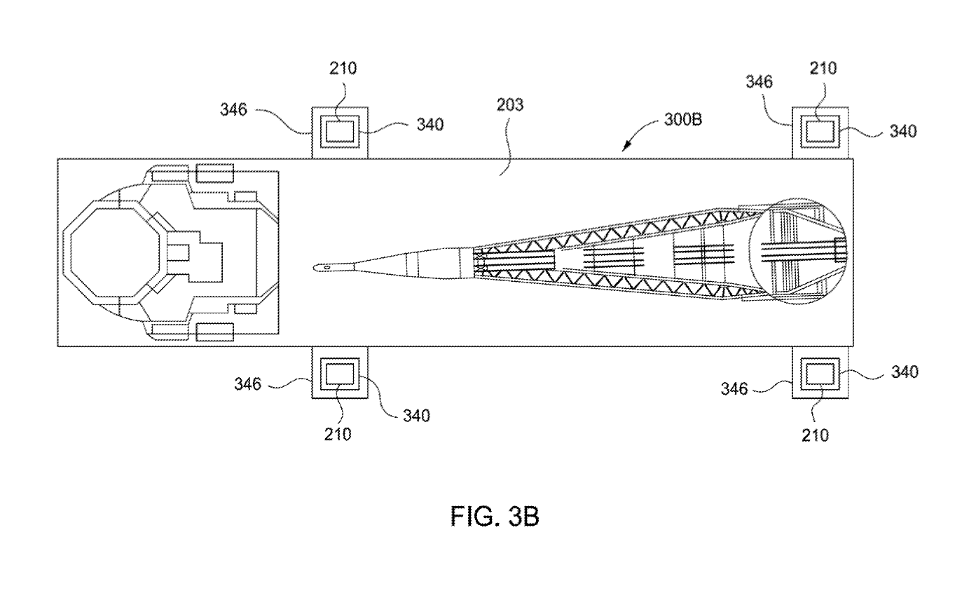

FIG. 3A is a top plan view of a crane barge 300A, according to one aspect of the disclosure. The crane barge 300A is similar to the crane barge 200. FIG. 3A illustrates the installation locations of jack-up legs 210. While four jack-up legs 210 are shown, it is contemplated that more or less than four jack-up legs 210 may be included. To accommodate the jack-up legs 210, openings 340 may be formed through the deck 203 and hull 218 of the crane barge 300A. The openings 340 may include sealed sidewalls to maintain vessel integrity. The openings 340 may have a shape which corresponds to the shape of the jack-up legs 210, for example, rectangular openings 340 for rectangular jack-up legs 210, or triangular openings 340 for triangular jack-up legs 210. The locations of the openings 340 may be selected to avoid interference with structural elements of the crane barge 300A, while still allowing the jack-up legs 210 to provide desired support.

FIG. 3B is a top plan view of a crane barge 300B, according to another embodiment of the disclosure. The crane barge 300B is similar to the crane barge 300A, however, the jack-up legs 210 are positioned outboard of the deck 203 (i.e. external to the hull). The crane barge 300B includes auxiliary decks 346 coupled to the port and starboard sides. The auxiliary decks 346 are retrofitted to an existing crane barge and include openings 340 therethrough for accommodating jack-up legs 210. The auxiliary decks 346 may be formed from steel or other structurally rigid material to facilitate support of the crane barge 300B on jack-up legs 210 when the jack-up legs 210 are extended into an operating position. The use of auxiliary decks 346 provides an alternative to forming openings through the deck 203, thereby simplifying retrofitting of a crane barge to include jack-up legs 210.

The crane barges 300A, 300B further include a crane hoist. The crane hoist is like the crane hoist 212 of FIG. 2. In one embodiment, the crane hoist is positioned on the deck. In other embodiments, the crane may be positioned in other locations. For example the crane hoist may be disposed surrounding the jack-up legs 210 or coupled to the auxiliary decks 346. The crane hoist may be positioned to allow the jack-up legs 210 to raise and lower unobstructed.

In an exemplary retrofitting process, an underutilized or decommissioned vessel, which may be advantageously compliant with the Jones Act, is selected. For example, the vessel may be a vessel previously used service vessel or a spare vessel such as a crane barge or another type of vessel. The vessel is modified (e.g., retrofitted) to include one or more jack-up legs. The jack-up legs may be jack-up legs 210 of FIGS. 3A or 3B for example. The design of the jack-up legs is selected in relation to, for example, desired loading, expected operational depth, or weight of the vessel. The vessel may be further modified to include additional equipment such as one or more cranes, crew accommodations, storage facilities, or combinations thereof.

Conversion of crane barges to jack-up crane barges provides new uses to otherwise limited, outdated, or decommissioned crane barges. By selecting American-made crane barges, the converted barges are Jones Act compliant, and therefore can be serviced by United States ports, shipyards, and crews, and can be brought to United States ports for maintenance or storage. The retrofitted crane barges disclosed herein can be moved from location-to-location to install offshore wind turbines, or to decommission or support offshore platforms, among other operations and functions.

While the foregoing is directed to embodiments of the present disclosure, other and further embodiments of the disclosure may be devised without departing from the basic scope thereof, and the scope thereof is determined by the claims that follow.

What is claimed is:

1. A method of modifying a vessel, comprising:
selecting a vessel; and
retrofitting the vessel to include one or more jack-up legs.

2. The method of claim 1, wherein the vessel is American-made and Jones Act compliant.

3. The method of claim 1, wherein the vessel is a crane barge.

4. The method of claim 1, further comprising modifying the vessel to include additional equipment.

5. The method of claim 4, wherein the additional equipment comprises one or more cranes, crew accommodations, storage facilities, or combinations thereof.

6. The method of claim 1, wherein the jack-up legs are disposed in a plurality of openings formed through a hull of the vessel.

7. The method of claim 1, wherein the jack-up legs are mounted to a hull of the vessel at an external location thereof.

8. The method of claim 7, wherein the vessel further comprise one or more auxiliary decks each having one or more openings formed therethrough, each jack-up leg disposed within the one or more openings of the one or more auxiliary decks.

9. A modified offshore vessel, comprising:
a hull; and
a plurality of jack-up legs retrofitted to the hull.

10. The vessel of claim 9, further comprising:
a hoist crane disposed on the hull.

11. The vessel of claim 10, wherein the hoist crane is retrofitted to the hull.

12. The vessel of claim 9, wherein the each jack-up leg of the plurality of jack-up legs are disposed within an opening formed through the hull.

13. The vessel of claim 9, wherein the plurality of jack-up legs are mounted to the hull at an external location thereof.

14. The vessel of claim 13, wherein the hull further comprises one or more auxiliary decks coupled to the hull.

15. The vessel of claims 14, wherein each auxiliary deck has one or more opening formed therethrough, each jack-up leg of the plurality of jack-up legs disposed within the one or more openings formed through the one or more auxiliary decks.

16. The vessel of claim 9, further comprising:
a superstructure for crew accommodations.

17. The method of claim 9, wherein the vessel is American-made and Jones Act compliant.
